(19) United States
(12) Patent Application Publication
(10) Pub. No.: US 2007/0243036 A1
(43) Pub. Date: Oct. 18, 2007

(54) Structure enhanced waterproof pull nail

(76) Inventor: Pao-Jen Chen, Taichung Hsien (TW)

Correspondence Address: PAO-JEN CHEN, 235 Chung - Ho, Box 8-24, Taipei, TW

(21) Appl. No.: 11/374,598

(22) Filed: Mar. 14, 2006

(51) Int. Cl. F16B 13/04

(52) U.S. Cl. 411/43

(57) ABSTRACT

A structure-enhanced-waterproof pull nail which comprises a nail having a head, a body and a neck connected between the head and the body; an outer diameter of the head being greater than that of the body; an auxiliary cover enclosing the head; two ends of the auxiliary cover being opened so that the neck and the head passing through e auxiliary cover; and a sleeve having an outer flange and a bottom cover; the sleeve serving for receiving the nail. The auxiliary cover and the sleeve are made of material selected from one of iron, carbon steel, stainless steel, aluminum, aluminum alloys, titanium, titanium alloys, copper, copper alloy, high molecular polymers, and synthetic material made by high temperature molding or natural material. An elastic washer is placed below the flange. Or a lower side of the flange is coated with high molecular polymer elastomer.

### FIELD OF THE INVENTION

The present invention relates to pull nails, and in particular to a structure-enhanced-waterproof pull nail, wherein the auxiliary cover can provide a great area for resisting against the work piece so that the combination of two work pieces are firm and steady. Thereby the elastomer or washer below the flange provides a preferred waterproof effect. As a whole, the pull mail of the present invention has a preferred waterproof effect.

### BACKGROUND OF THE INVENTION

With reference to FIGS. 1 to 3, a prior art pull nail is illustrated. The prior art pull nail has a sleeve 2 and a rod body 5. The sleeve has a flange 2-3 at one end and a distal hole 2-2 at another end. The rod body 5 has a pull rod 4 and a head 3. The pull rod 4 has a neck 4-1 at a position near the head 3. The pull rod 4 can be inserted into the sleeve 2. The prior art pull nail has no function of waterproof.

Referring to FIG. 5, the pull nail is beaten into two work pieces 6, 7. Then the pull rod 4 is pulled so that the head 3 is enforced into the sleeve 2 to be retained therein. Finally, the pull rod 4 is pulled out to separate from the head 3. In FIG. 3, it is illustrated that the surface 2-3 of the sleeve 2 has a vapor permeation path 1-1 and in the process, an enlarged portion 2-1 is formed.

Referring to FIGS. 4, 5 to 6-1, a vapor permeation path 1-1 is formed at an interior of the sleeve 8-1. A washer 6 is installed at a position between the flange and the work piece 6. FIG. 6 shows the process for manufacturing a prior art pull nail. Material 9 is formed to have different semi-products 9-1, 9-2, 9-3, 9-4, 9-5, 9-6. In 9-6, the sleeve has a thin wall. Then a pull rod 5 is inserted into the sleeve. Then the inner diameter of the sleeve is reduced (in 9-7). Then the sleeve is compressed to fit the outer shape of the pull rod 5 so that the portion enclosing the neck 4-1 is thicker and has an inclined surface 9-8 and the portion enclosing the head 3 is thinner, as illustrated by 9-7 and 9-8. Then the flange portion of the sleeve 2 is punched to have a cambered shape protruded from the sleeve surface 2-3, as shown in 9-9. FIG. 6-1 is a perspective view about the shaping of the prior art. Firstly, the slits 9-10 are formed. Then the slits 9-20 are formed. The slits 9-10 and 9-20 form the sheets 9-30. Then in various processes, the semi-products 9-1, 9-2, 9-3, 9-4, 9-5 are formed by punching the sheets 9-30, wherein the holes 9-40 are guided holes in the manufacturing process.

The defect of the prior art is that the head 3 is inserted into the sleeve 8-1. The size of the head 3 must be smaller than that of the sleeve 8-1. However this will induce that the enlarged portion 2-1 cannot be too larger. Thereby it is not sufficient for the sleeve to the fixed on the work piece 7 (referring to FIG. 3).

### SUMMARY OF THE INVENTION

Accordingly, the primary object of the present invention is to provide a structure-enhanced-waterproof pull nail, wherein the auxiliary cover can provide a great area for resisting against the work piece so that the combination of two work pieces are firm and steady. Thereby the elastomer or washer below the flange provide a preferred waterproof effect. As a whole, the pull mail of the present invention has a preferred waterproof effect.

To achieve above objects, the present invention provides a structure-enhanced-waterproof pull nail which comprises a nail having a head, a body and a neck connected between the head and the body; an outer diameter of the head being greater than that of the body; an auxiliary cover enclosing the head; two ends of the auxiliary cover being opened so that the neck and the head passing through e auxiliary cover; and a sleeve having an outer flange and a bottom cover; the sleeve serving for receiving the nail. The auxiliary cover and the sleeve are made of material selected from one of iron, carbon steel, stainless steel, aluminum, aluminum alloy, titanium, titanium alloy, copper, copper alloy, high molecular polymers, and synthetic material made by high temperature molding or natural material. An elastic washer is placed below the flange. Or a lower side of the flange is coated with high molecular polymer elastomer.

The various objects and advantages of the present invention will be more readily understood from the following detailed description when read in conjunction with the appended drawing.

### BRIEF DESCRIPTION OF THE DRAWINGS

FIG. 1 is a perspective view of a prior art pull nail.

FIG. 2 is an exploded view of the prior art pull nail.

FIG. 3 is an assembled cross sectional view of the prior art pull nail.

FIG. 4 is a perspective view of a prior art waterproof pull nail.

FIG. 5 is an assembled view of the prior art waterproof pull nail.

FIG. 6 shows the process of the manufacturing a prior art pull nail.

FIG. 6-1 is a perspective view about the manufacturing process of the prior art pull nail.

FIG. 7 is the perspective view of structure-enhanced-waterproof pull nail of the present invention.

FIG. 7-1 shows the nail body of the present invention.

FIG. 8 is an assembled cross sectional view of the waterproof pull nail of the present invention.

FIG. 9 shows the manufacturing process of the present invention.

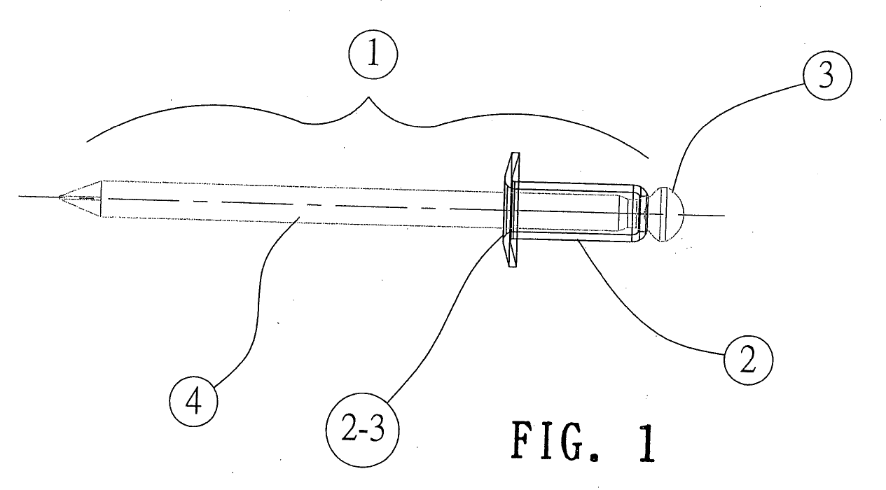

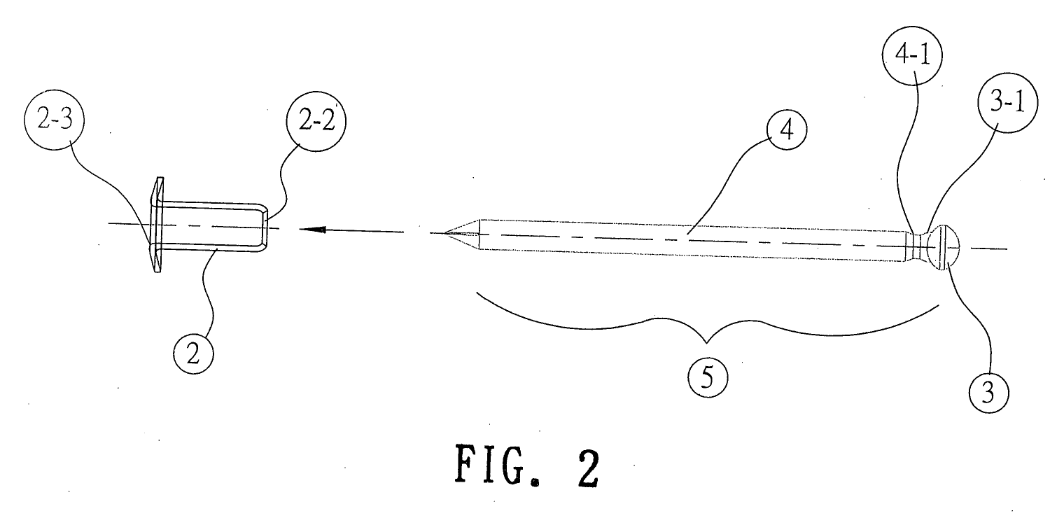

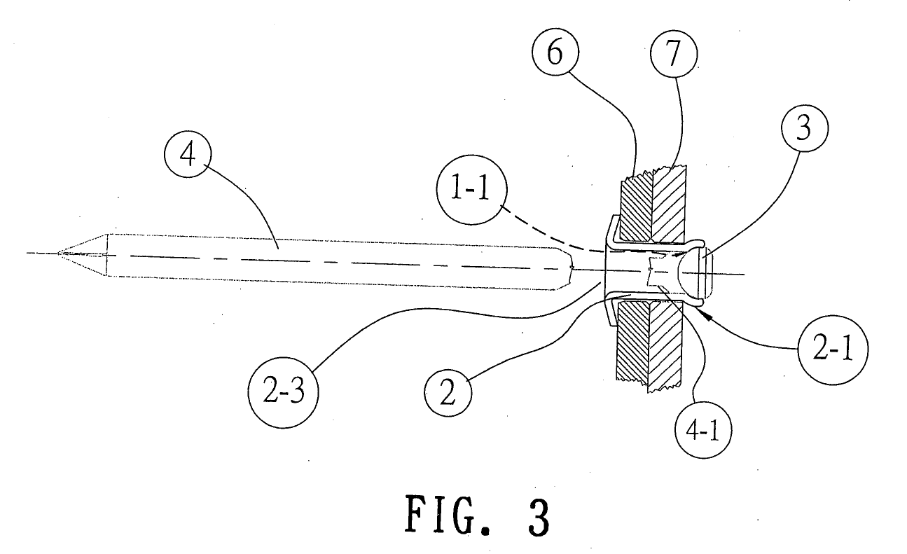

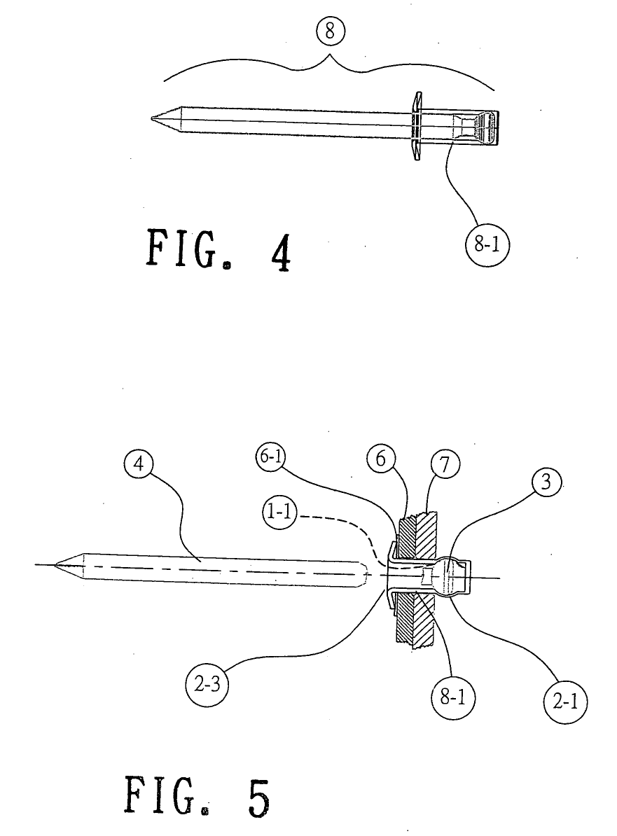

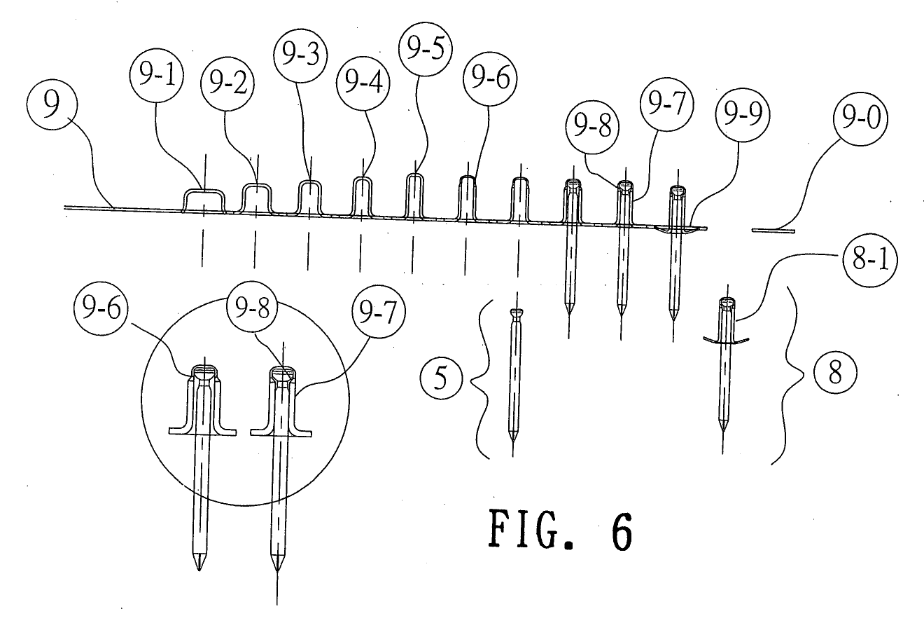

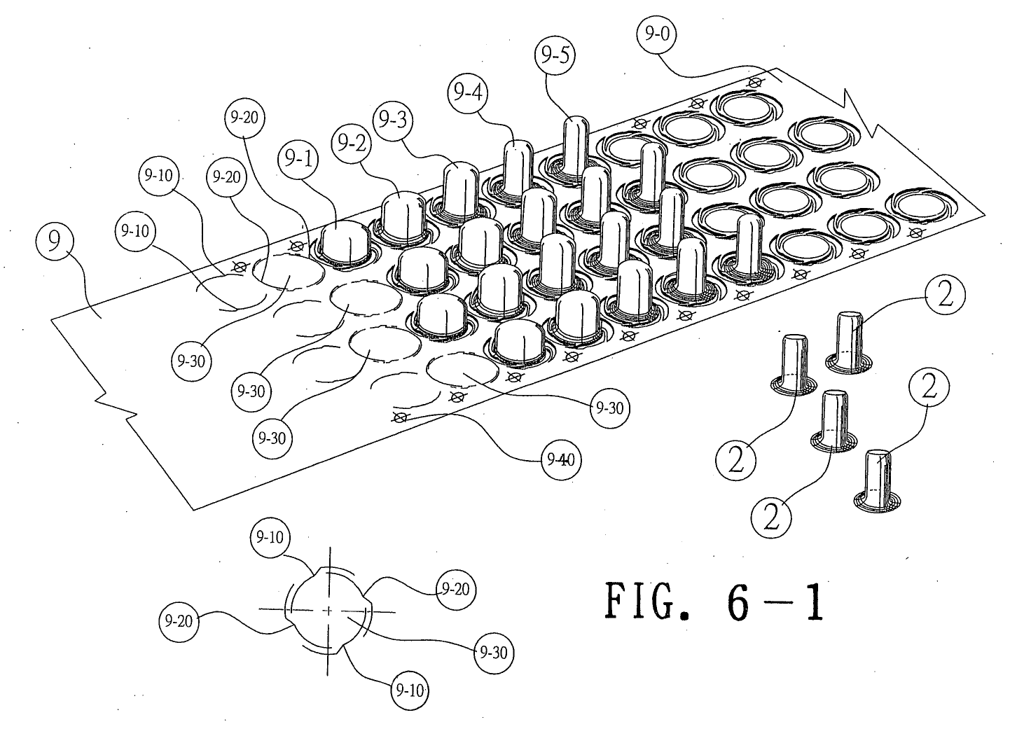

### DETAILED DESCRIPTION OF THE INVENTION

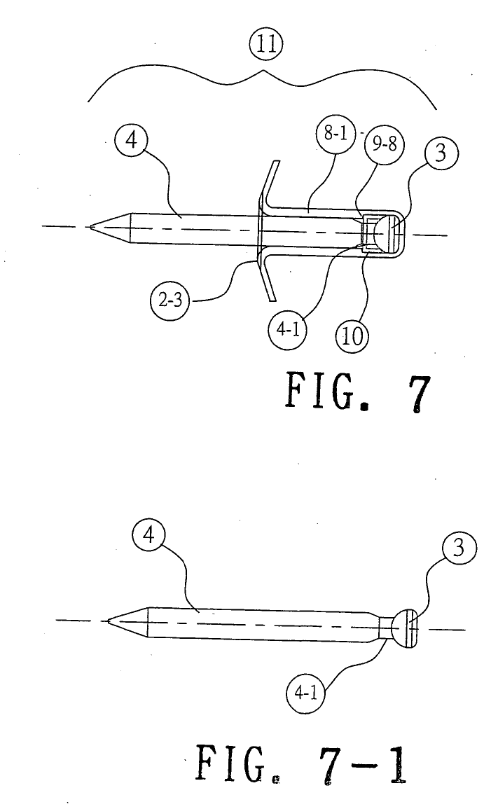

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIGS. 7 to 9, the present invention is illustrated. The structure-enhanced-waterproof pull nail device 11 of present invention has the following elements.

A nail 5 has a head 3, a body 4 and a neck 4-1 connected between the head 3 and the body 4. An outer diameter of the head 3 is greater than that of the body 4. An auxiliary cover 10 encloses the head 3. Two ends of the auxiliary cover 10 are opened so that the neck 4-1 and the head 3 can pass through the auxiliary cover 10.

A sleeve 8-1 has an outer flange 2-3 and a bottom cover 2-3. The bottom cover 2-3 is thinner than other portion of the sleeve 8-1.

In the present invention, the auxiliary cover 10 and the sleeve are made of material selected from one of iron, carbon steel, stainless steel, aluminum, aluminum alloys, titanium, titanium alloys, copper, copper alloys, high molecular polymers, or synthetic material made by high temperature molding or natural material.

Moreover in the present invention, an elastic washer 6-1 can be placed below the flange 2-3 or the lower side of the flange is coated with high molecular polymer elastomer.

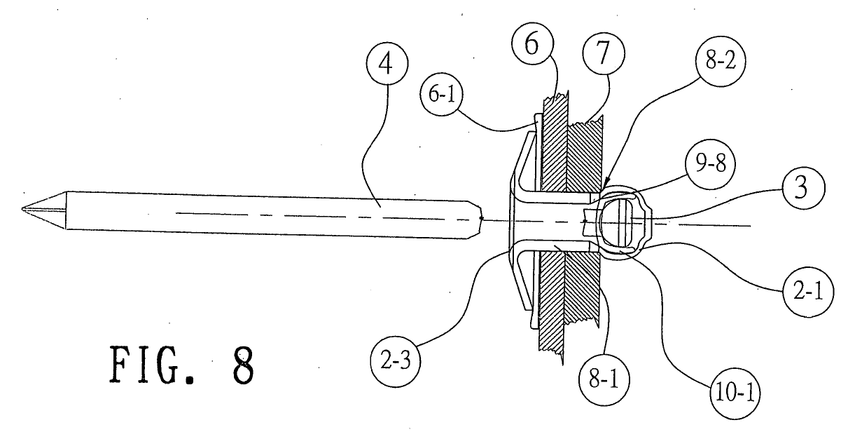

Referring to FIG. 8, the operation of the present invention is illustrated. Two work pieces 6, 7 are to be combined. At first, a hole is formed for receiving the pull nail 5 of the present invention. A washer 6-1 is placed upon the work piece 6 and below the flange 2-3. After the pull nail 5 is placed into the hole and the auxiliary cover 10-1 protrudes from the hole. Then the nail 4 is pulled out. As a result the head will expand the auxiliary cover 10 and the bottom cover 2-1 so that the auxiliary cover 10, the bottom cover 2-1 and the head 3 resists against the work piece 7. Then an inclined outer surface 9-8 of the auxiliary cover 10 is an inclined surface with a small diameter section near the neck 4-1. Therefore, the two work pieces are combined.

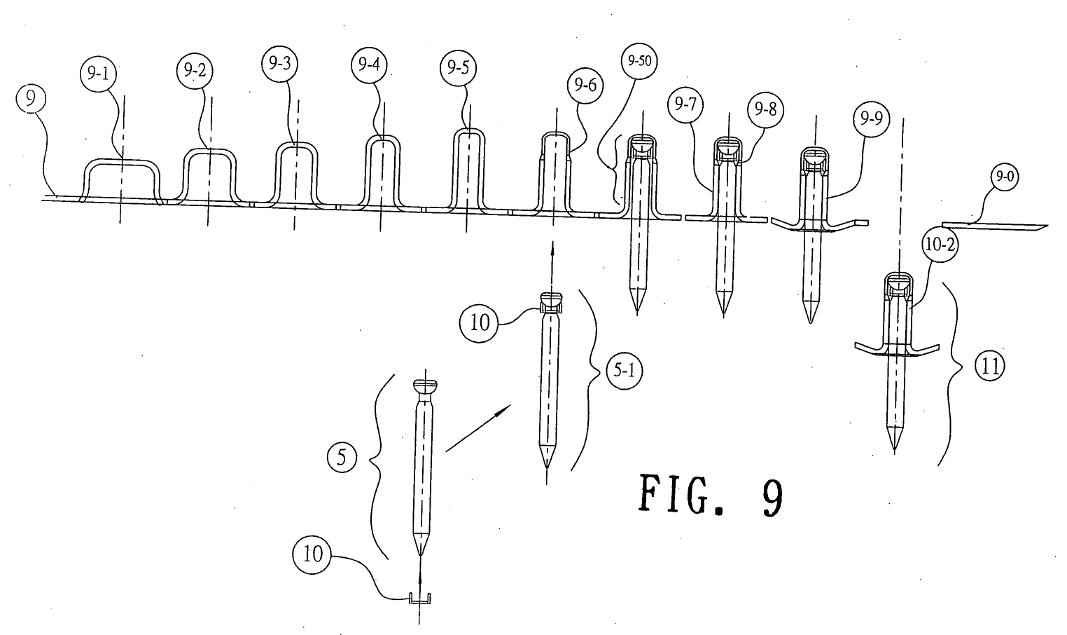

Referring to FIG. 9, the process of the present invention is illustrated. in the process of 9, 9-1 to 9-5, the sleeve is formed. Then the bottom cover of the sleeve is thinned as illustrated in 9-6. The auxiliary cover 10 is placed upon the head 3 from the side of the body 4 so as to enclose the head 3 and is confined by the neck 4-1. In the processes of 9-50, 9-8, and 9-9, the nail 5 is placed into the sleeve 8-1. The sleeve 8-1 is cut and the flange 2-3 is formed.

Advantages of the present invention will be described herein. The auxiliary cover can provide a great area for resisting against the work piece so that the combination of two work pieces are firm and steady. Thereby the elastomer or washer below the flange provides a preferred waterproof effect. As a whole, the pull mail of the present invention has a preferred waterproof effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A structure-enhanced-waterproof pull nail comprising:
a nail having a head, a body and a neck connected between the head and the body; an outer diameter of the head being greater than that of the body;
an auxiliary cover enclosing the head; two ends of the auxiliary cover being opened so that the neck and the head passing through e auxiliary cover; and
a sleeve having an outer flange at one end thereof and a bottom cover at another end thereof; the sleeve serving for receiving the nail.

2. The structure-enhanced-waterproof pull nail as claimed in claim 1, wherein the bottom cover is thinner than other portions of the sleeve.

3. The structure-enhanced-waterproof pull nail as claimed in claim 1, wherein the auxiliary cover is made of material selected from one of iron, carbon steel, stainless steel, aluminum, aluminum alloys, titanium, titanium alloys, copper, copper alloys, high molecular polymers, and synthetic materials made by high temperature molding and natural materials.

4. The structure-enhanced-waterproof pull nail as claimed in claim 1, wherein the sleeve is made of material selected from one of iron, carbon steel, stainless steel, aluminum, aluminum alloys, titanium, titanium alloys, copper, copper alloys, high molecular polymers, and synthetic materials made by high temperature molding and natural materials.

5. The structure-enhanced-waterproof pull nail as claimed in claim 1, wherein an elastic washer is placed below the flange.

6. The structure-enhanced-waterproof pull nail as claimed in claim 1, wherein a lower side of the flange is coated with high molecular polymer elastomer.
